(19) United States
(12) Patent Application Publication
(10) Pub. No.: US 2004/0062196 A1
(43) Pub. Date: Apr. 1, 2004

(54) Single shelf router

(75) Inventors: Chris Gunner, Harvard, MA (US); Mark Hamilton, Upton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avici Systems, Inc., North Billerica, MA

(21) Appl. No.: 10/302,808

(22) Filed: Nov. 21, 2002

Related U.S. Application Data
(60) Provisional application No. 60/415,087, filed on Oct. 1, 2002.

(51) Int. Cl. H04J 1/16

(52) U.S. Cl. 370/222

(57) ABSTRACT

A fabric of modules includes a plurality of physically offset adjacent modules and first dimension links which, in at least one linear array of modules, connect single offset modules in a ring. The fabric also includes second dimension links which connect the modules of each linear array in at least one ring with substantially all links between modules in each array being double offset links bypassing a single module, and third dimension links which connect modules of each linear array in at least one ring with substantially all links between modules in each array being triple offset links bypassing two modules.

### RELATED APPLICATION

This application claims the benefit of U.S. Provisional Application No. 60/415,087, filed Oct. 1, 2002, the entire contents of which are incorporated herein by reference.

### BACKGROUND

Computer systems come in a variety of topologies. Systems that include multiple data processing modules (or nodes) often have complex topologies. The interconnection assemblies that connect the modules of such topologies are often complicated, as well. In particular, it is a demanding task for an interconnection assembly to provide several connections (or links) to each module, as required by certain systems having mesh-shaped configurations such as a torus.

A typical multi-module computer system has an interconnection assembly that includes a backplane, module connectors and flexible wire cables. The backplane is a rigid circuit board to which the module connectors are mounted. Each module is a circuit board that electrically connects with the backplane when plugged into one of the mounted module connectors. The flexible wire cables connect with the backplanes to configure the system into a network topology having a particular size.

The network topology of a typical multi-module computer system is expandable by adding modules to a backplane and adding backplanes and reconnecting the flexible wire cables to configure the system into a larger network topology. Generally, the topology of the system is expanded by several modules at a time. For example, one such system having a 4×4×4 torus topology is expanded by adding a 16-module backplane and reconnecting the flexible wire cables to expand the system up to a 4×4×5 torus topology. Some systems permit expansion by hot plugging, i.e., plugging and unplugging cables to expand the topology of the system while the power is on.

A similar topology has been used in a multi-node router as disclosed in U.S. Pat. Nos. 6,205,532 and 6,370,145, incorporated by reference in their entireties.

### SUMMARY

A fabric of modules includes a plurality of physically offset adjacent modules and first dimension links which, in at least one linear array of modules, connect single offset modules in a ring. The fabric also includes second dimension links which connect the modules of each linear array in at least one ring with substantially all links between modules in each array being double offset links bypassing a single module, and third dimension links which connect modules of each linear array in at least one ring with substantially all links between modules in each array being triple offset links bypassing two modules.

The second dimension links may form two rings, each ring being formed of five modules with all links between modules in each of the rings being double offset.

The third dimension links may form a first ring with four modules, and a second ring with six modules. In certain embodiments, the links between the four modules of the first ring have offsets of 1, 3, 3, and 3, and the connections between the six modules of the second ring have offsets of 3, 3, 5, 3, 3, and 3, where an offset is defined as the number of slots spaced from a particular module.

There may be plural arrays of modules interconnected by the third dimension links which extend the at least one ring. The links between the arrays may be single offset links.

An assembly of modules connected in a fabric may include a backplane having module connections to receive modules and leads for interconnecting the modules in at least a first dimension, a first and a second link connector coupled to each module, a first interconnector configured to connect the first link connectors in a first set of link connectors, and a second interconnector configured to connect the second link connectors in a second set of link connectors. The interconnectors may have leads to connect the modules in a second dimension. Two assemblies can be connected in the second dimension by removing the first interconnector from a first assembly and the second interconnector from a second assembly and connecting the respective first and second sets of link connectors.

The backplane may have leads for interconnecting the modules in a third dimension.

In some embodiments, four assemblies are connected in the second dimension by removing the first interconnector from the second assembly, both interconnectors from a third assembly, and the second interconnector from a fourth assembly, and connecting the first set of link connectors of the second assembly with the second set of link connectors of the third assembly, and the first set of link connectors of the third assembly with the second set of link connectors of the fourth assembly.

A fabric of modules may include, in at least one array of modules, at least two physically offset adjacent modules connected in at least a first dimension, and one or two filler modules that occupy respective open slots physically adjacent to the at least two adjacent modules. The filler modules are connected to the at least two adjacent modules in the first dimension and a second dimension.

The at least two physically offset adjacent modules may include three modules interconnected in the first and second dimensions, and the at least one filler module may include two filler modules. In some embodiments, the at least two physically offset adjacent modules includes four or more modules interconnected in the first, second, and third dimensions.

Other embodiments include methods of connecting the various configurations of the aforementioned fabric of modules.

Some embodiments may have one or more of the following advantages. The fabric architecture facilitates using a single array or shelf of modules as a router. A user can add modules one at a time to the fabric in a single shelf of modules. The build out of the fabric is quite flexible. That is, the modules can be added to the fabric in a number of ways since there is little constraint as to how modules can be added. The fabric facilitates building multiple shelves into a single router. The use of filler modules provides for rich fabric diversity, since a greater number of links are generated with the fillers. Hence, the fabric is more resilient to fabric failures because of the redundancy provided by the links created with the fillers.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is perspective view of a backplane of a router with a set of modules in accordance with the invention.

FIG. 1B is a perspective view of the opposite side of the backplane of FIG. 1A shown with interconnectors.

FIG. 2A illustrates the basic fabric architecture of the router of FIGS. 1A and 1B.

FIG. 2B illustrates the physically interconnection of the fabric architecture of FIG. 2A when all ten slots are occupied by modules.

FIG. 3 illustrates the X fabric connectivity of the fabric architecture of FIG. 2A.

FIG. 4A illustrates the Y fabric connectivity of the fabric architecture of FIG. 2A.

FIG. 4B illustrates the physically interconnection of the Y fabric connectivity of FIG. 4A.

FIG. 4C illustrates a four node ring of the Y fabric connectivity of FIG. 4A.

FIG. 4D illustrates a six node ring of the Y fabric connectivity of FIG. 4A.

FIG. 5 illustrates the Z fabric connectivity of FIG. 2A.

FIG. 6 illustrates the fabric topology of the fabric architecture of FIG. 2A.

FIG. 7 illustrates two modules with fabric filler modules.

FIG. 8 illustrates three modules with fabric filler modules.

FIG. 9 illustrates four modules with fabric filler modules.

FIG. 10 illustrates five modules with fabric filler modules.

FIG. 11 illustrates six modules with fabric filler modules.

FIG. 12 illustrates seven modules with a single fabric filler module.

FIG. 13 illustrates eight modules positioned between two servers.

FIG. 14A illustrates the basic fabric architecture of a router with two shelves.

FIG. 14B illustrates the physically interconnection of the modules of the router of FIG. 14A.

FIG. 15A illustrates an eight node ring of the Y connectivity of the router of FIG. 14A.

FIG. 15B illustrates a twelve node ring of the Y connectivity of the router of FIG. 14A.

FIG. 16 illustrates the basic fabric architecture of a router with four shelves.

FIG. 17A illustrates a sixteen node ring of the Y connectivity of the router of FIG. 16.

FIG. 17B illustrates a twenty four node ring of the Y connectivity of the router of FIG. 16.

FIG. 18 illustrates the basic fabric architecture of a router with two shelves and a stackable router.

FIG. 19 illustrates the build out order of a single shelf.

FIG. 20 illustrates a shelf with two generation modules.

FIGS. 21A-21E illustrate various configurations of a two shelf multi-generation build out of modules.

FIG. 22 illustrates a three shelf multi-generation build out of modules.

### DETAILED DESCRIPTION OF THE INVENTION

A description of preferred embodiments of the invention follows.

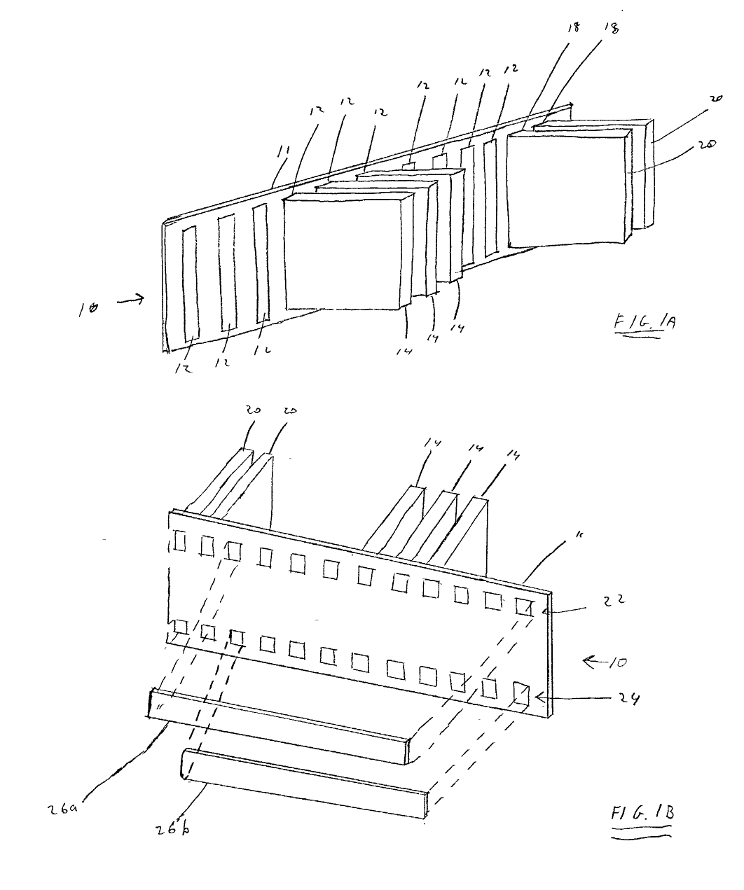

There is shown in FIG. 1A a shelf 10, alternatively referred to as a bay, of a router system that is, for example, interconnected with other router systems of a multi-mode data processing system such as an internet router formed by a network of fabric routers, or a multi-computer system. Internet switch routers formed by networks of fabric routers are described in U.S. Pat. No. 6,370,145, the entire teachings of which are incorporated herein by reference.

The shelf 10 includes a backplane 11 with ten module slots 12 arranged in one shelf. The slots 12 are provided with module connections which receive respective modules 14. The backplane 11 is also provided with a set of slots 18 for a pair of controllers 20 that coordinate environmental monitoring for the router system.

The fabric topology of the shelf 10 forms a three-dimensional hypermesh in contrast to the three-dimensional toroidal mesh of the router systems described in U.S. Pat. No.6,205,532, and U.S. Application entitled “Rack Mounted Routers,” by Coutinho, Briggs, and DeLisle, filed Sep. 19, 2002, Attorney Docket No. 2390.2004-001, referred to hereinafter as “stackable routers,” incorporated by reference in their entireties. The shelf 10 supports small module populations with sufficient fabric diversity, and allows for modules to be added one at a time to the shelf. Furthermore, the same modules that operate in the routers described in U.S. Pat. No. 6,205,532, and the stackable routers can operate in the shelf 10 as well.

A single shelf 10 can function as a router, in which each module is a fabric router. Alternatively, two or more shelves 10 can be interconnected and assembled, for example, in a single rack, forming a single connected router. Further, two or more shelves 10 can also be configured with a stackable router forming a single connected router. Typically, the shelf 10 supports a minimum of two servers 20. However, if servers are not present in a shelf then those slots are available for modules 14. The shelf 10 is also able to support multiple generation modules. For instance, certain modules can operate at 5 Gbps, while others operate at 10 Gbps, 20 Gbps, and/or at 40 Gbps. Typically, the ten modules 14 of a single shelf 10 are interconnected in three dimensions, and the number of offsets between linked modules in each dimension are minimized to maximize flexibility of module population where an offset is defined as the number of slots spaced from a particular module. In one dimension, single offset modules are connected in a ring, and in a second dimension, double offset modules are connected in two rings. In a third dimension, mostly triple offset modules are connected in two rings, but since ten modules cannot be divided entirely into whole sets of three, there is a single offset module and a module having an offset of five. Of course, if the router is formed with a different number of modules, then the rings of the various dimensions will have different sizes.

The following discussion in conjunction with the figures describes the fabric topology and physical architecture of one or more shelves 10 in various configurations. In the figures, the following conventions are used:

Circles represent module slots.

Numbered circles represent modules, with the number identifying the particular slot location.

Circles labeled “F” represent filler modules.

Circles labeled “S” represent servers.

In figures showing multi-generation modules, shaded circles labeled “1” represent generation 1 modules, and shaded circles labeled “2 ” represent generation 2 modules.

An arrowed arc represents a fabric link, where the arrow end represents a plus fabric end point, and the non-arrow end represents a minus fabric end point. Further,

Arcs identified by the reference numeral 50 are Z fabric links.

Arcs identified by the reference numeral 60 are X fabric links.

Arcs identified by the reference number 70 are Y fabric links.

Arcs identified by the reference number 80 are fabric links connected through a filler module; that is, a connected X and Z link

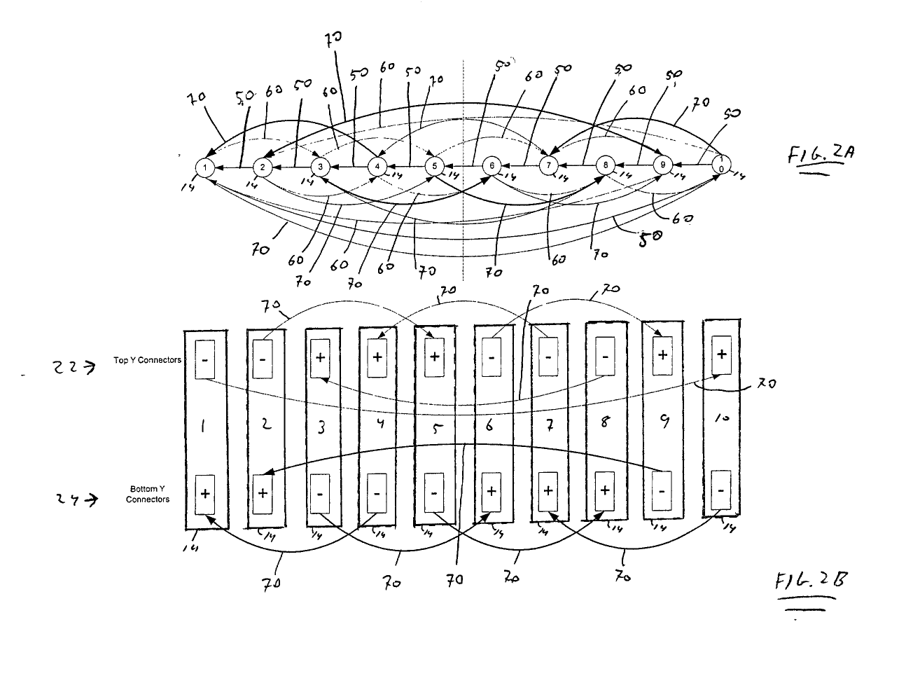

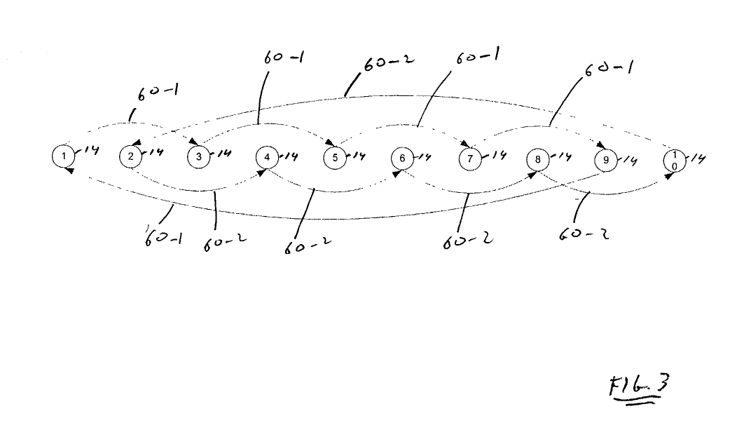

FIG. 2A shows the basic fabric architecture of the shelf 10. The interconnection of the X and Z dimensions are contained within the single backplane 11 (FIGS. 1A and 1B). The Y dimension provides the extensibility to multi-shelves and stackable router configurations. As shown in FIG. 2B, as well as FIG. 1B, the Y fabric links are wired to an upper row 22 and a lower row 24, each of ten Y, or link, connectors. To provide a high degree of fabric diversity in a single shelf configuration and in multi-shelf configurations, each row of ten Y connectors has an external interconnector assembly 26a and 26b (FIG. 1B) that connects these into five Y fabric links per row.

As shelves are added to a router, some of these Y interconnectors 26a and 26b are removed and inter-shelf Y connector cables are installed in their place. As shown in FIG. 2B, the polarity of the Y fabric links is mixed in each row so that the interconnectors can be manufactured as two separate pieces—one for each of the rows, each being completely independent of the other. This makes the manufacture of the interconnectors easier and more economical, as well as simplifying the multi-shelf expansion procedure.

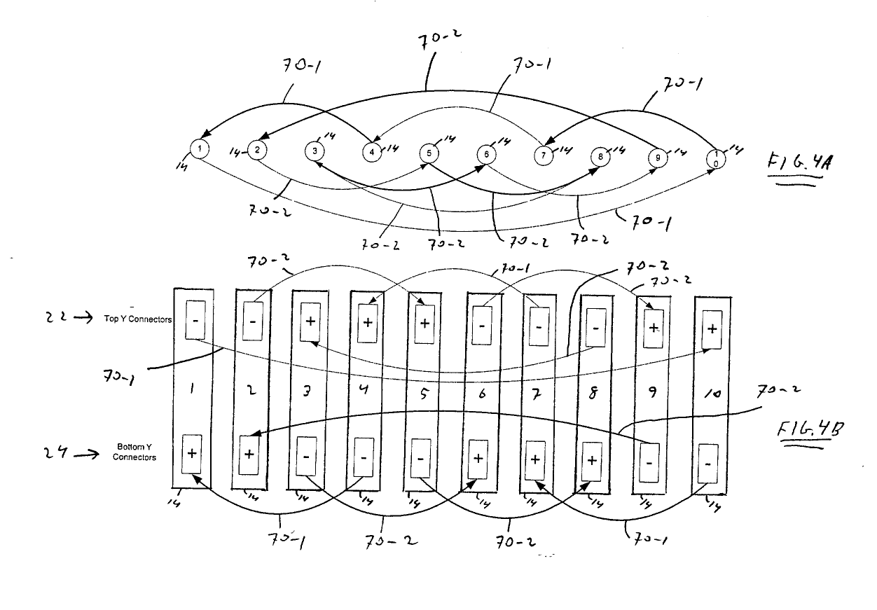

Referring to FIG. 3, the X fabric includes two interleave-by-two rings of five nodes or modules. The first ring is formed by the interconnections of the modules in the slots 1, 3, 5, 7, and 9, as indicated by the arcs 60-1, and the second ring is formed by the interconnections of the modules in the slots 2, 4, 6, 8, and 10, as identified by the arcs 60-2. Thus, since slots 1 and 10 are considered physically adjacent to each other, the offset between the five modules linked in each ring is 2, 2, 2, 2, and 2, where the offset is defined as the number of slots spaced from a particular module.

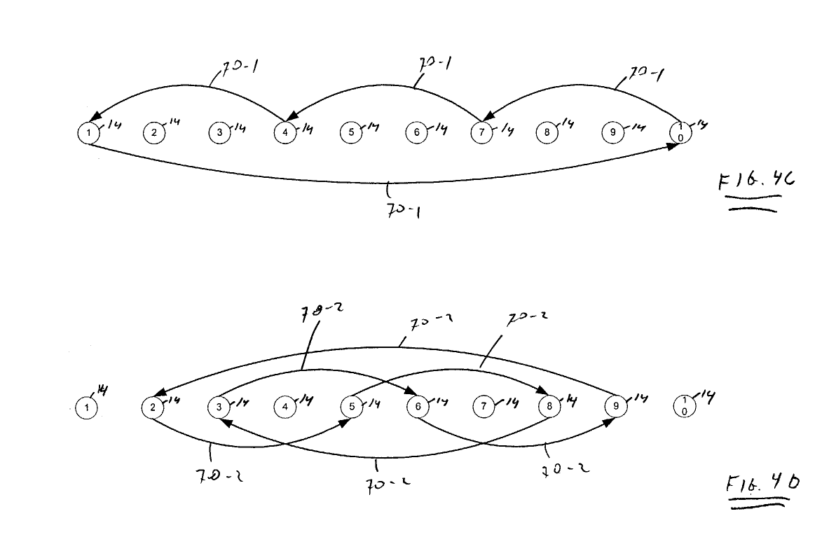

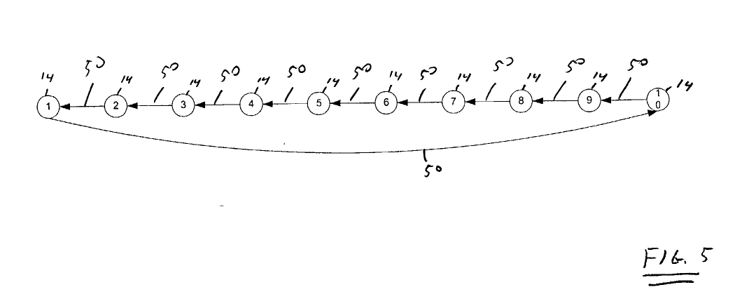

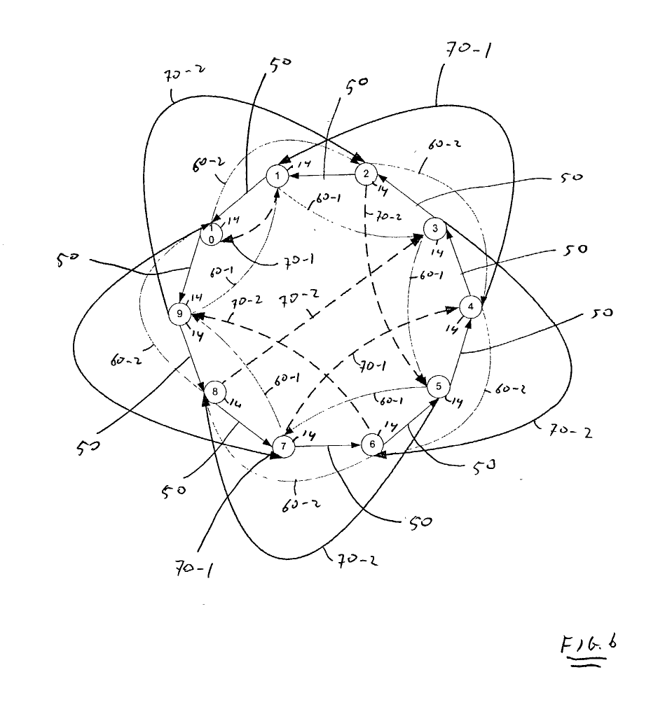

Referring now to FIG. 4A, the fabric layout for the Y dimension is formed of two interleave-by-three rings, identified individually in FIGS. 4C and 4D. When both interconnectors 26 (FIG. 1B) are installed on the respective row of connectors 22 and 24, the first of the two rings is a four node ring formed by interconnecting the modules in slots 1, 4, 7, and 10, as indicated by the arcs 70-1 (FIG. 4C), and the second ring is a six node ring formed by interconnecting the modules in slots 2, 3, 5, 6, 8, and 9, as indicated by the arcs 70-2 (FIG. 4D). Here, the offset between the modules in the ring shown in FIG. 4C beginning from the module in slot 1 is 1, 3, 3, and 3, and the offset between the modules in the ring shown in FIG. 4D beginning from the module in slot 2 is 3, 3, 5, 3, 3, and 3.

Referring to FIG. 5, the fabric in the Z dimension is formed of a single ring of ten nodes, such that modules in adjacent slots are connected as indicated by the arcs 50. Hence, the offset between the linked modules is 1.

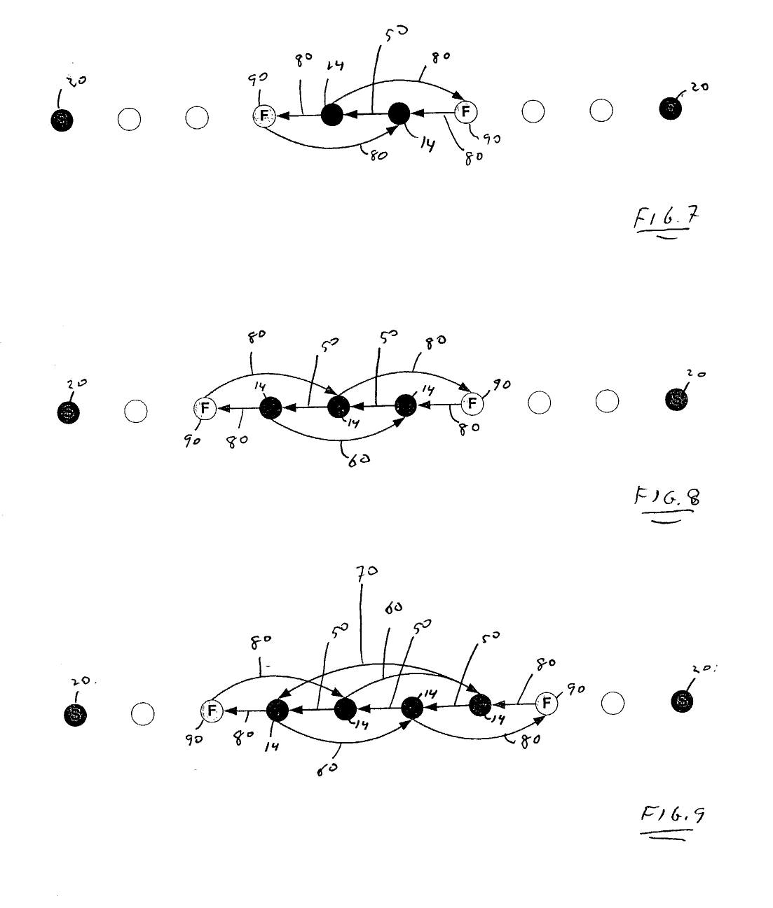

For ease of visualization of the interleaved ring structures, FIG. 6 shows the basic fabric topology of the shelf 10 represented as a wrapped circle of slots.

The fabric thus described provides for odd as well as even numbered module populations. Further, under most single failure modes, the above fabric provides for good fabric diversity.

Under normal operations, or after any single failure mode of a link, there are three active fabric links on each module 14, with the following exceptions: a single module system has zero fabric links active, resulting in throughput being limited to the self-forwarding performance of a single module; a three module system in which the middle module fails results in one active fabric link between the remaining 2 modules; a four module system in which any module fails results in one or more modules with only two active fabric links; and a seven module system in which module the third module fails results in the second module having only two active fabric links.

Fabric filler modules are used to provide reasonable fabric diversity and support one at a time module build out. A fabric filler module is a passive wiring device that connects the +X to −Z fabric end points and the −X to +Z fabric end points in the slot in which it is placed. In some implementations, the filler module provides both of these connections. Filler modules are placed at the “edges” of the contiguous set of modules in the shelf. A good analogy for the placement rules is that of “book ends”. In the same way that one places a book end at the edge of a set of books on a book shelf, so one places a fabric filler module at the edge of a set of modules in a shelf. In addition, the filler is only used when the slot adjacent to the edge (if there is such a slot) is empty; that is, the slot does not contain a server. By connecting X and Z end points together, the filler provides a physical “bridge” that allows a fabric link to form between the next two slots adjacent to it.

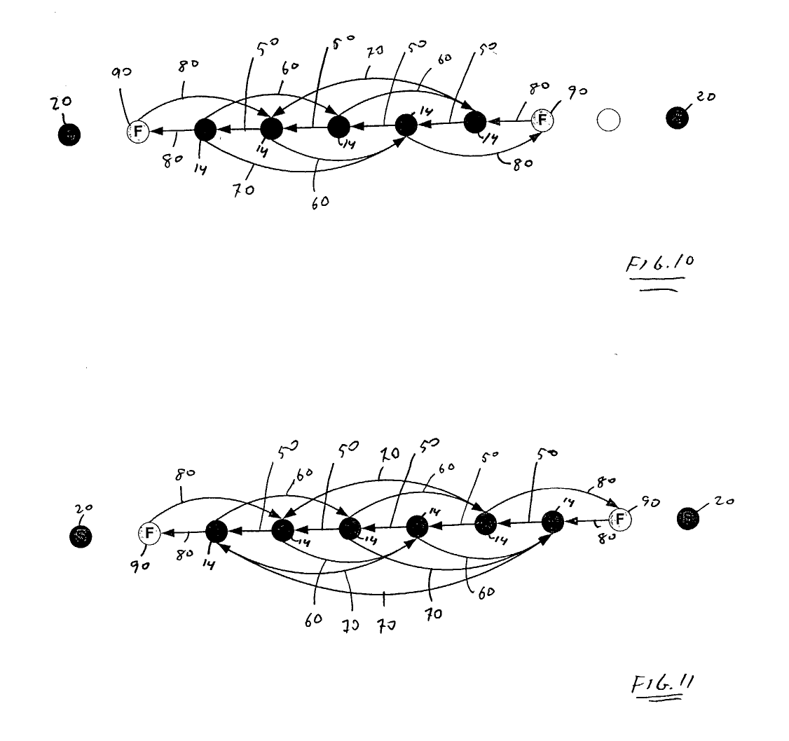

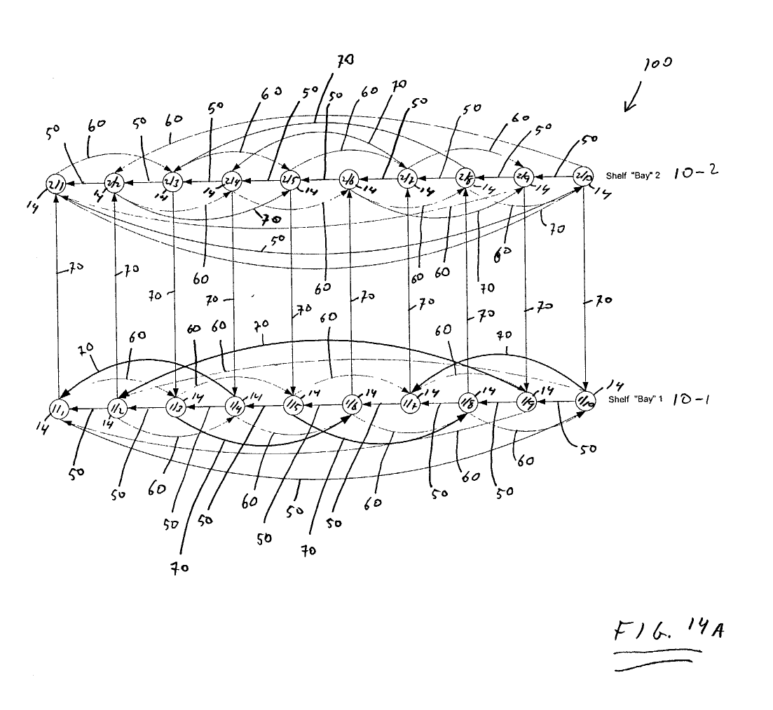

Examples of the use of filler modules are illustrated in FIGS. 7-12. As shown, severs 20 are positioned at the end slots in an array of ten slots, and two or more modules 14 are positioned between the servers. FIG. 7 shows filler modules 90 at both edges of the set of modules 14, creating an extra fabric link 80 in addition to the X fabric link 50. This results in the two modules 14 being connected with three active fabric links instead of the one link 50 that would exist with no filler modules. Note that if the filler modules 90 are omitted or fail, then the effect on the configuration is simply to remove fabric links from the topology. A filler module failure never results in a partition of the modules—only a possible reduction of fabric throughput.

FIG. 8 shows a three module configuration in which the modules 14 are positioned between two filler modules 90, and are connected together by Z and X fabric links 50 and 60, as well as the extra fabric links 80.

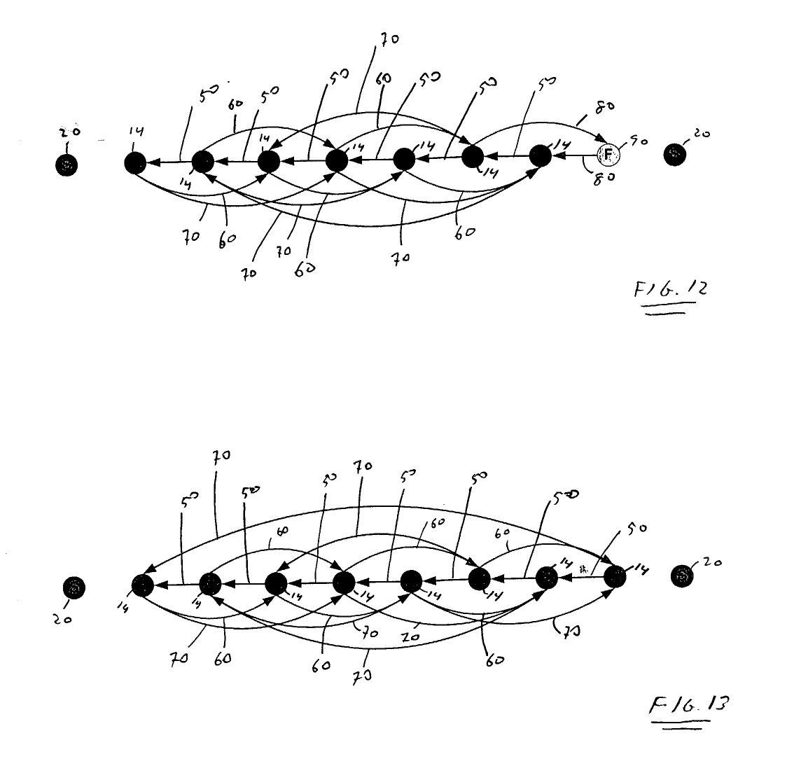

For the four, five, and six module configurations shown in FIGS. 9, 10, and 11, respectively, the X, Y, and Z fabric links 60, 70, and 50, as well as the extra links 80, are employed to connect the modules 14 together.

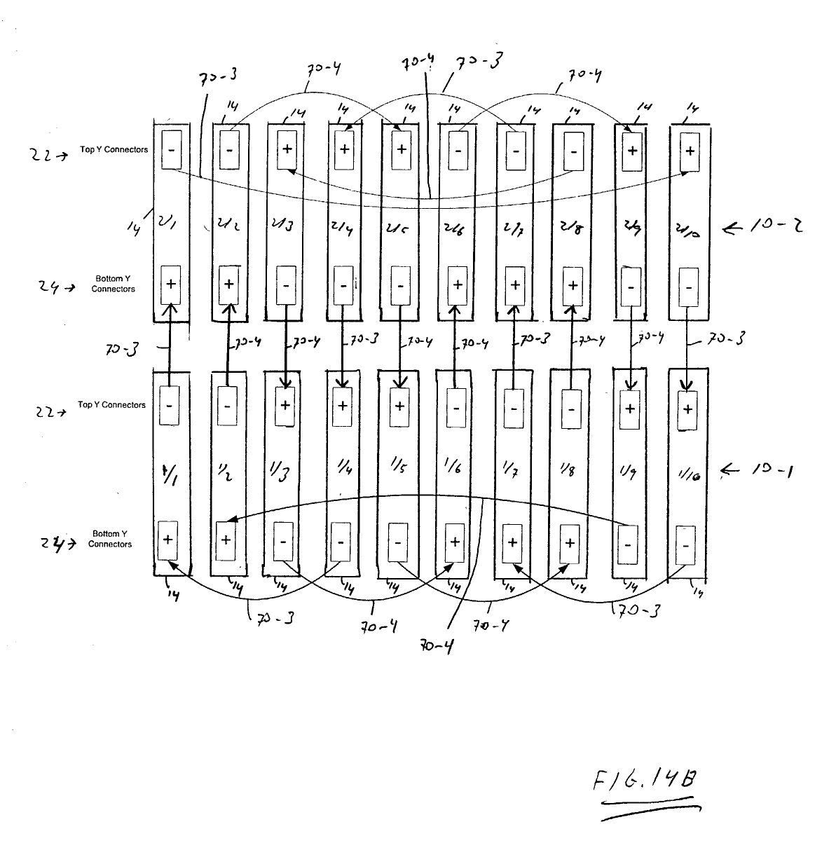

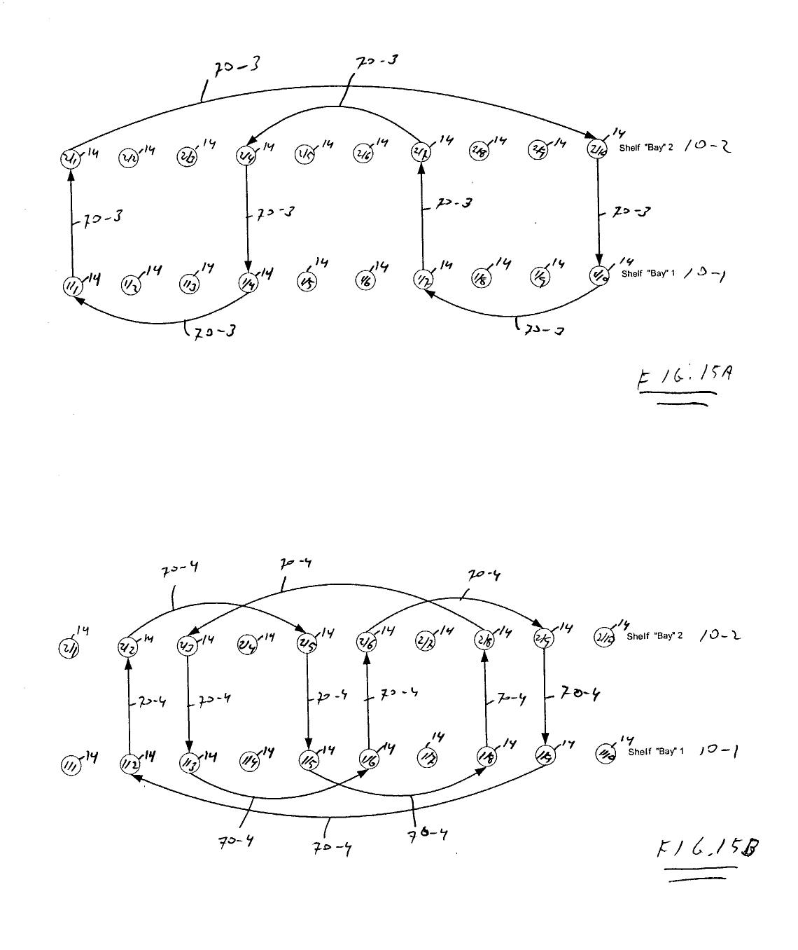

As mentioned above, filler modules are not required when the slot adjacent to the edge module is occupied by a server. For instance, as shown in FIG. 12, only a single filler module 90 is used, which occupies the slot between the right-most module 14 and the server 20. The seven modules 14 are connected together by X, Y, and Z fabric links 60, 70, and 50 and to the single filler module 90 with the extra link 80. Since the slot next to left-most module 14 is occupied by a server 20, a filler module is not used there. Similarly, the edge modules 14 in the configuration shown in FIG. 13 are adjacent to slots occupied by servers, thus no filler module is used in this configuration. Hence, the eight modules in FIG. 13 are linked together by X, Y, and Z fabric links 60, 70, and 50, without the use of the extra fabric links 80.

In some embodiments, the server package includes the fabric filler function as well so that when a server is present in a slot it provides the fabric filler function for its adjacent pair of module slots.

In some arrangements, two or more shelves 10 are interconnected to form a single router. For example, referring to FIG. 14, there is shown a two shelf configuration 100 formed of an upper bay 10-2 and a lower bay 10-1, where each bay serves a number of management purposes and corresponds to a single shelf. Since the bottom shelf and the top shelf are identified by the numbers “1” and “2”, respectively, the slot numbering for the system 100 is 1/1 through 1/10 for the bottom shelf and 2/1 through 2/10 for the top shelf.

In this multi-shelf configuration, the bottom shelf 10-1 retains its bottom Y interconnector 26b (FIG. 1B) while the top shelf 10-2 retains its top Y interconnector assembly 26a (FIG. 1B), and the top row of connectors 22 of the bottom shelf 10-1 are connected to the bottom row of connectors 24 of the top shelf 10-2, as illustrated in FIG. 14B, with, for example, Y inter-shelf connector cables.

As such, the extensibility to multi-shelves occurs through the Y fabric links 70, while the X and Z fabric links 60 and 50 remain the same for each shelf. In such two-shelf implementations, the Y fabric is formed of an eight-node ring (FIG. 15A) and a twelve-node ring (FIG. 15B), as indicated by the Y fabric links 70-3 and 70-4, respectively. The fabric links 70-3 connect the modules 1/1, 2/1, 2/10, 1/10, 1/7, 2/7, 2/4, and 1/4 with the offsets 1, 1, 1, 3, 1, 3, 1, and 3 beginning from module 1/1. The twelve-node Y ring of FIG. 15B is formed by the interconnections of the fabric links 70-4 connecting the modules 1/2, 2/2, 2/5, 1/5, 1/8, 2/8, 2/3, 1/3, 1/6, 2/6, 2/9, and 1/9 with the offsets 1, 3, 1, 3, 1, 5, 1, 3, 1, 3, 1, and 3 when beginning from the module in the slot 1/2.

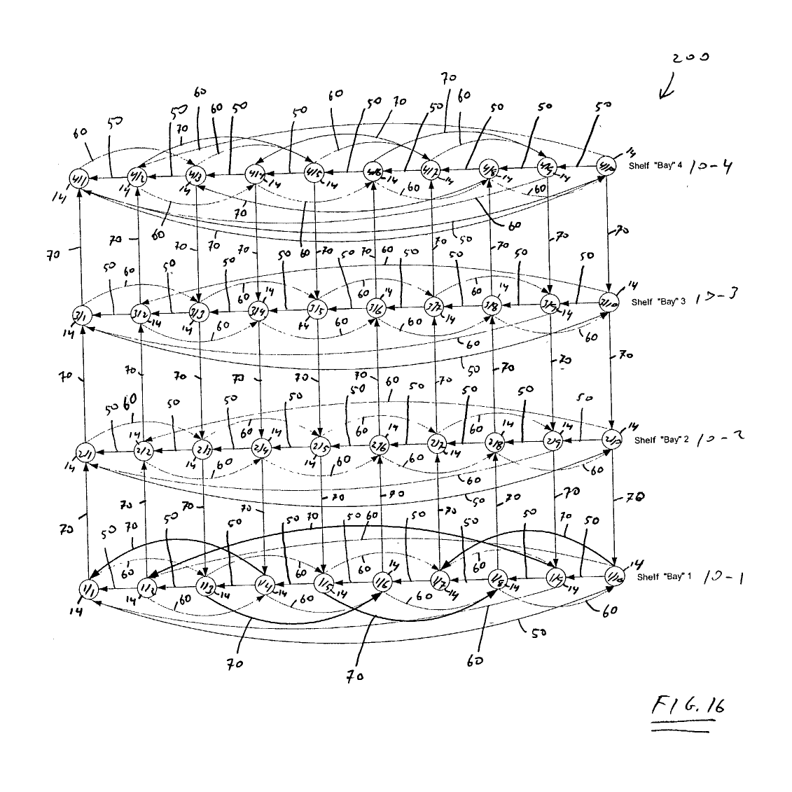

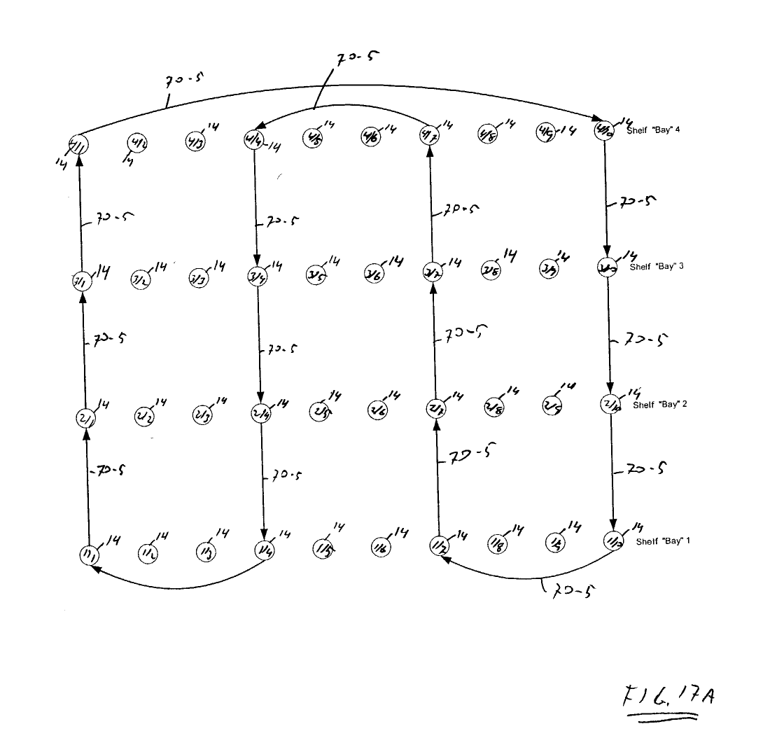

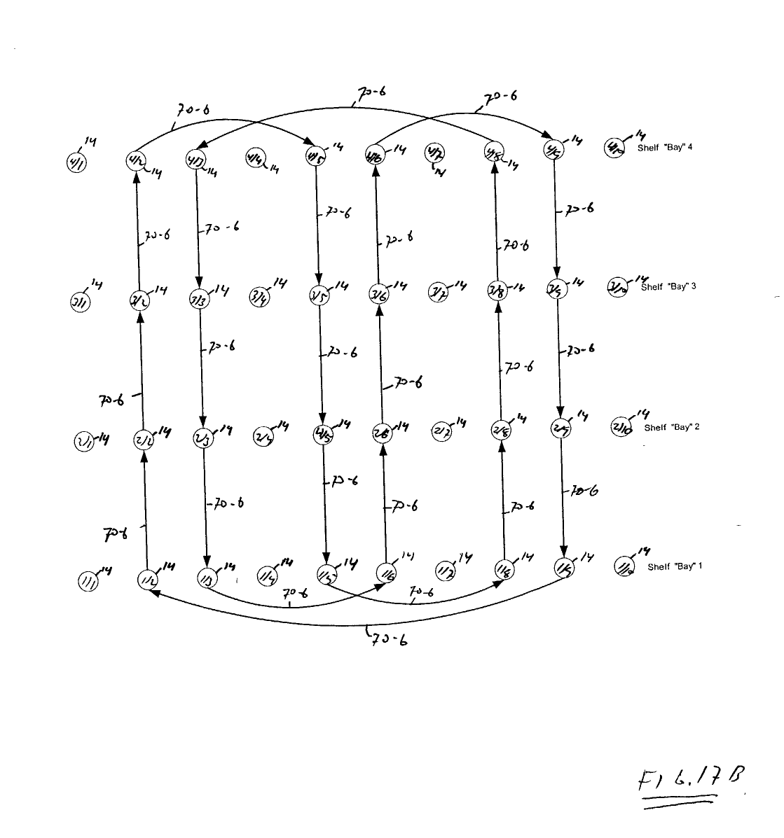

By extension of the above two-shelf configuration, a four shelf 200 system can easily be configured from the four bays 10-1, 10-2, 10-3, and 10-4, as illustrated in FIG. 16, in which the slot numbering for the system 200 is 1/1 through 1/10 for the shelf 10-1, 2/1 through 2/10 for the shelf 10-2, 3/1 through 3/10 for the shelf 10-3, and 4/1 through 4/10 for the shelf 10-4.

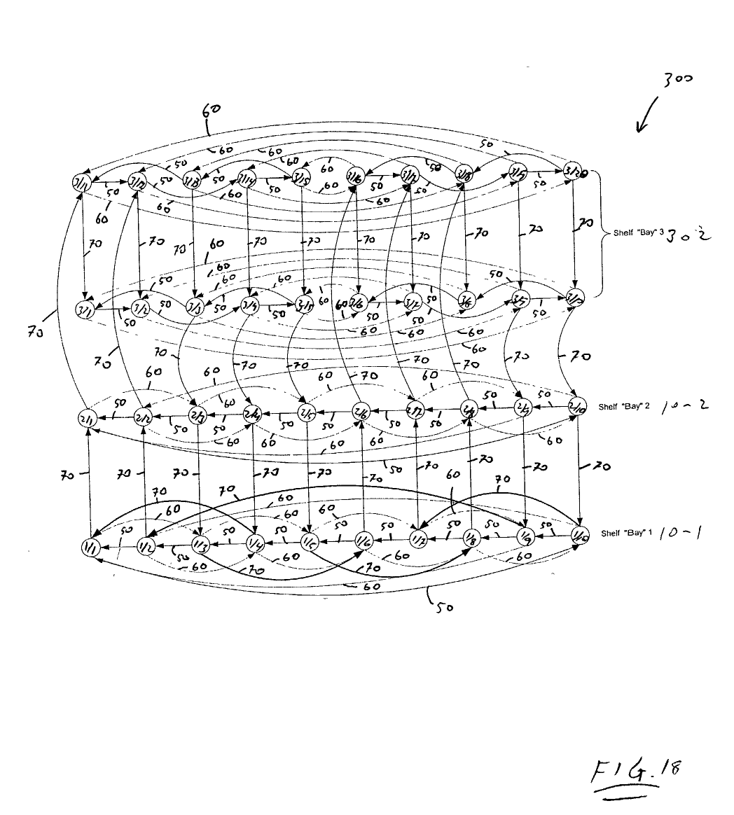

Again the X and Z fabric links 60 and 50 of the system 200 remain in place for each shelf, while the interconnection between the shelves occurs in the Y dimension. To form the Y fabric links 70, both the top and bottom Y interconnectors 26a and 26b (FIG. 1B) are removed from the shelves 10-2 and 10-3, while the bottom Y interconnector 26b is removed from the top shelf 10-4 and the top Y interconnector 26a is removed from the bottom shelf 10-1. The shelves are physically connected together with Y connector cables, such that: the top row of connectors 22 (FIG. 1B) of the bottom shelf 10-1 is connected to the bottom row of connectors 24 of the second shelf 10-2; the top row of connectors of the second shelf 10-2 is connected to the bottom row of connectors of the third shelf 10-3; and the top row of connectors of the third shelf 10-3 is connected to the bottom row of connectors of the top shelf 10-4, with the connections between the top and bottom row of connectors being made like that shown in FIG. 14B for the two shelf configuration. The Y fabric thus formed for the four shelf configuration is made of a first ring (FIG. 17A) in which sixteen modules are interconnected by the Y fabric links 70-5, and a second ring (FIG. 17B) in which twenty four modules are interconnected by the Y fabric links 70-6.

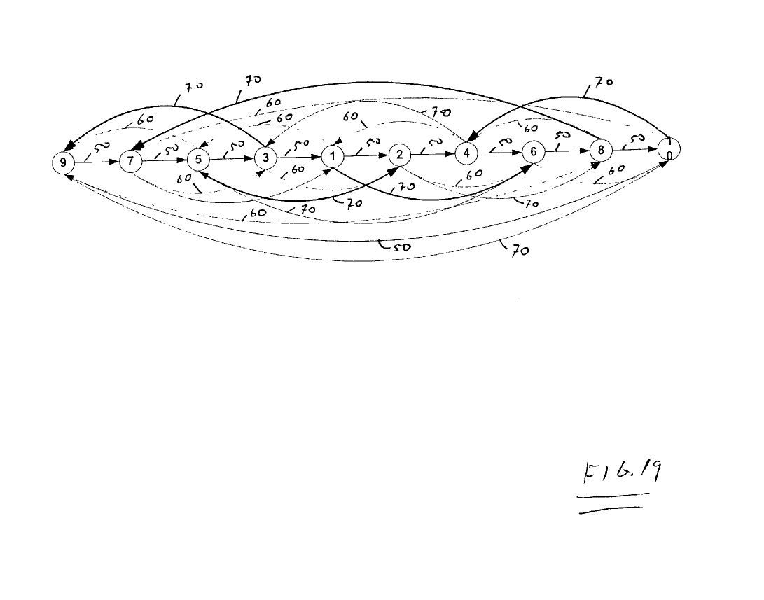

The shelves 10 can be combined with other types of router systems, such as the stackable router mentioned earlier. For example, there is shown in FIG. 18 a single router system 300 formed of two shelves 10-1 and 10-2 and a stackable router 302 in which the two shelves of the router 302 are considered a single bay. Hence, the slot numbering for the system 300 is 1/1 through 1/10 for the bottom shelf 10-1, 2/1 through 2/10 for the second shelf 10-2, and 3/1 through 3/20 for the stackable router 302. As before, the interconnection between the shelves 10-1, 10-2, and the stackable router 302 occurs through the Y fabric links 70, while the X and Z fabric links 60 and 50 remain as they were in the single shelf configuration. Note that the Y inter-shelf connector cables between the topmost shelf 10-2 and the stackable router 302 connect to the top (3/1-3/10) or bottom (3/11-3/20) shelf of the stackable router 302 depending on the shelves' Y polarity.

For the shelves 10 and the systems 100, 200, and 300 discussed above, certain build out rules are typically followed to add modules to the various configurations, as outlined below:

Place servers 20 in slots 10 and 1, or in slot 10 if there is only a single server.

Place the first two module in slots 5 and 6 in the first shelf 10, and filler modules 90 in slots 4 and 7.

Add modules 14 one or more at a time in the slot order: 4, 7, 3, 8, 2, and 9. As each module is added, shift the filler module 90 to the next adjacent slot.

Fill up the first shelf 10-1 before filling the second shelf 10-2.

To install the second shelf, remove top Y interconnectors 26a from first shelf 10-1 and the bottom Y interconnectors 26b from the second shelf 10-2, and install ten inter-shelf Y connector cables to the respective connectors.

Build the second shelf in the same way as the first shelf. Note that the first increment of modules in the second shelf is at least two modules.

By extrapolation, build the third and forth shelves 10-3 and 10-4 the same way.

To connect the two shelves 10-1 and 10-2 with a stackable router 302, fill the shelves 10-1 and 10-2 first, and then add a minimum of four modules in the center of the shelves of the stackable router (slots 3/5, 3/6, 4/15, and 4/16 as shown in FIG. 16)

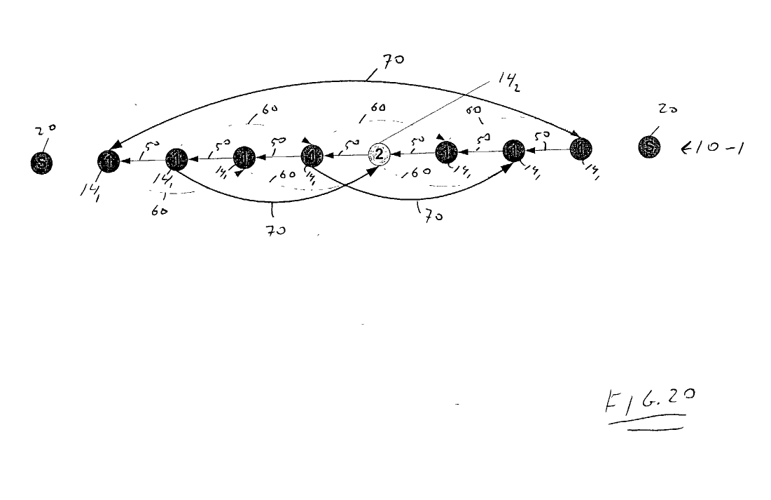

Then add two modules at a time in the stackable router 302 in an X ring. The build out order for a single shelf 10 following the above procedure is illustrated in FIG. 19, where the circled numbers indicate the order in which the modules are placed in the shelf.

The shelves 10 can accommodate different generation modules, which operate at different speeds. Typically, the general principle of the build out of multi-generation modules is to cluster higher speed generation modules in adjacent slots both horizontally and vertically. In a single shelf, a cluster of one generation of modules can be any number of modules in any set of adjacent slots with either different generation modules at the edges or filler modules. In configurations with multiple shelves, a cluster of one generation of modules is also adjacent vertically in Y, but with an “overhang” of a different generation module allowed at the cluster edges. The cluster is at least 2 modules wide horizontally in all shelves. Further, in multiple shelves, a cluster of one generation of modules can extend vertically in 1, 2, 3 or 4 shelves and need not extend vertically through all the shelves.

Examples of the build out of multiple-generation modules are illustrated in FIGS. 20, 21A-21E, and 22. FIG. 20 shows a single shelf with a single generation two module 14₂, operating, for example, at 20 Gbps, and multiple generation one modules 14₁, operating, for example, at 10 Gbps. Note that all the fabric links 50, 60, and 70 attached to the generation two module 14₂ are operating at the generation one speed, for example, 10 Gbps.

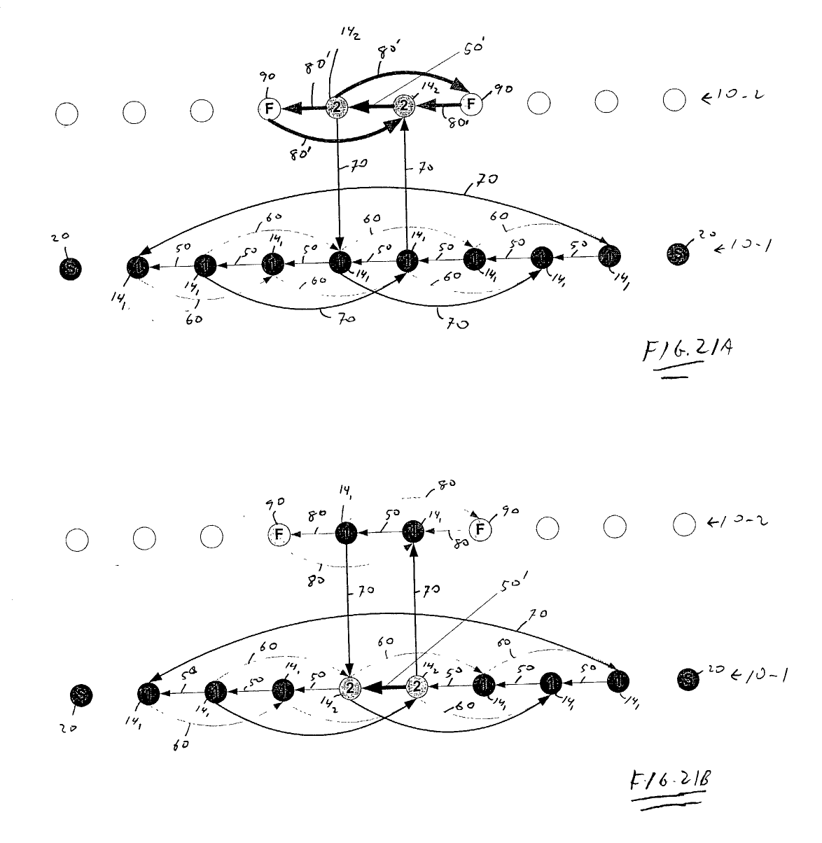

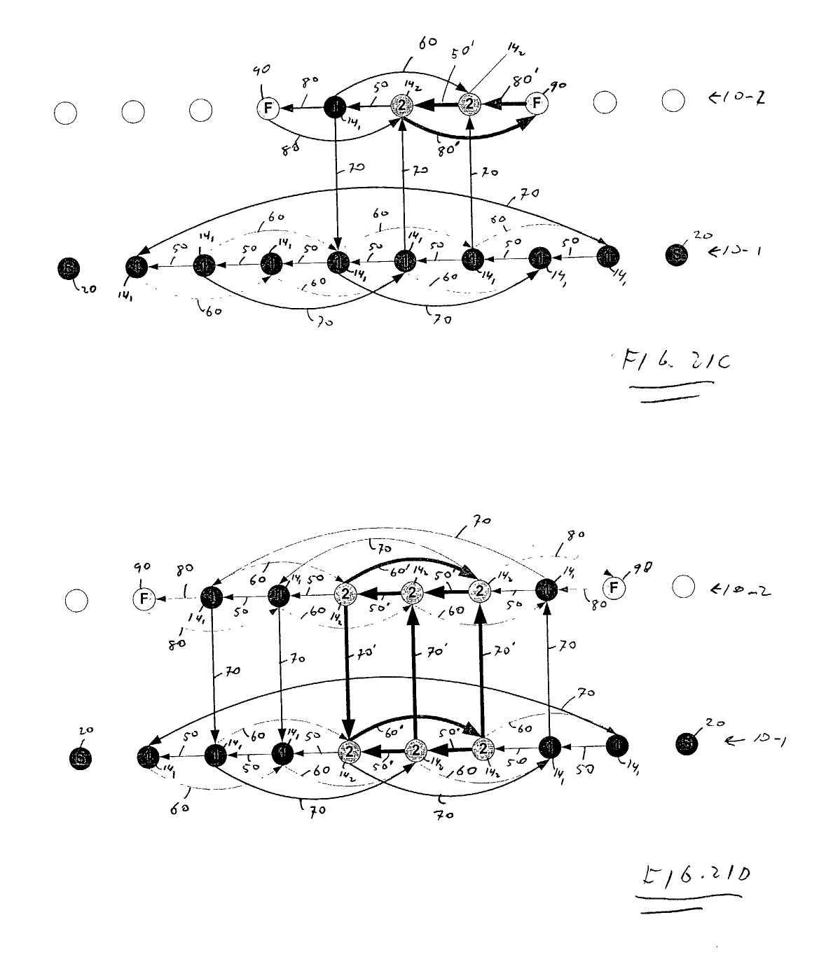

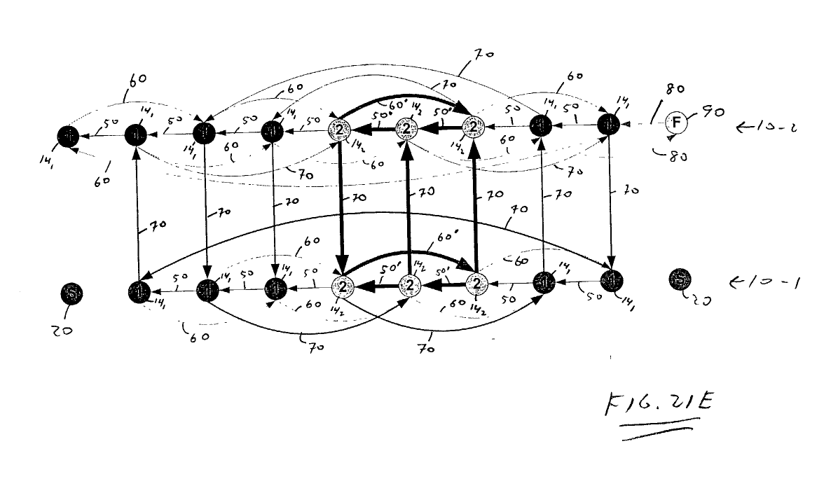

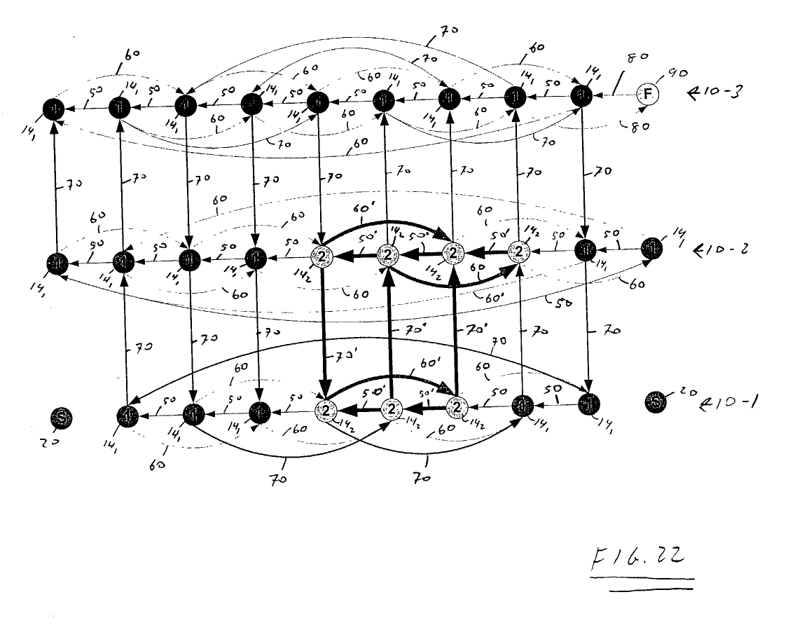

FIGS. 21A-21E show two generation modules built out in two shelves 10-1 and 10-2 interconnected in the Y dimension by the Y fabric links 70. As outlined above, the first shelf 10-1 is built out to at least eight slots, before starting the new shelf 10-2 with two additional modules.

In FIG. 21A, eight slots of the bottom shelf 10-1 are filled with generation one modules 14₁ interconnected with X and Z links 60 and 50, while the two center slots of the top shelf 10-2 are filled with generation two modules 14₂ connected together with a generation two link 50′ and to two filler modules 90 with the extra links 80′. Note that the primed links in FIG. 21A, as well as in FIGS. 21B-22 discussed below, indicate links operating at the generation two speeds.

In contrast, the configuration shown in FIG. 21B has generation one modules 14₁ in the two center slots of the second shelf 10-2, and two generation two modules 14₂ in the center slots of the first shelf 10-1 along with six other generation one modules 14₁. Here the high speed link 50′ is established between the generation two modules 14₂ in the first shelf. In general, compared to the configuration of FIG. 21A, the configuration shown in FIG. 21B provides better cross-sectional bandwidth between the generation two modules and the generation one modules to support a traffic pattern where all traffic goes between generations, although such a traffic pattern is not likely since generation two modules may be used as uplinks to core routers.

FIG. 21C shows a configuration in which the first shelf 10-1 is populated with eight generation one modules 14₁, and the second shelf 10-2 is populated with two generation two modules 14₂ and a single generation one module 14₁, between two filler modules 90.

In FIGS. 21D and 21E, both shelves 10-1 and 10-2 are provided with generation one modules 14₁ and generation two modules 14₂. For FIG. 21D, the bottom shelf 10-1 is filled with eight modules and thus does not use filler modules, while the top shelf 10-2 is filled with six modules and is therefore provided with two filler modules next to the edge modules. For the configuration of FIG. 21E, only one filler module is used to fill the slot next to the right-most generation one module 14₁ in the second shelf 10-2. The outlined build out procedure for multi-generation modules can be easily extended to three or more shelves, as shown in FIG. 22.

While this invention has been particularly shown and described with references to preferred embodiments thereof, it will be understood by those skilled in the art that various changes in form and details may be made therein without departing from the scope of the invention encompassed by the appended claims.

What is claimed is:

1. A fabric of modules comprising:
a plurality of physically offset adjacent modules;
in at least one linear array of the modules, first dimension links which connect single offset modules in a ring;
second dimension links which connect the modules of each linear array in at least one ring with substantially all links between modules in each array being double offset links bypassing a single module; and
third dimension links which connect the modules of each linear array in at least one ring with substantially all links between modules in each array being triple offset links bypassing two modules.

2. The fabric of modules of claim 1 wherein the second dimension links form two rings, each ring being formed of five modules with all links between modules in each of the rings being double offset.

3. The fabric of modules of claim 1 wherein the at least one linear array of modules includes plural arrays of modules interconnected by third dimension links which extend at least one ring.

4. The fabric of modules of claim 1 wherein the third dimension links form a first ring with four modules, and a second ring with six modules.

5. The fabric of modules of claim 4 wherein the links between the four modules of the first ring have offsets of 1, 3, 3, and 3, and the links between the six modules of the second ring have offsets of 3, 3, 5, 3, 3, and 3.

6. The fabric of modules of claim 5 wherein the at least one linear array of modules includes plural arrays of modules interconnected by third dimension links which extend the at least one ring.

7. The fabric of modules of claim 6 wherein the links between the arrays are single offset links.

8. An assembly of modules connected in a fabric comprising:
a backplane having module connections to receive modules and leads for interconnecting the modules in at least a first dimension;
a first and a second link connector coupled to each module;
a first interconnector configured to connect first link connectors in a first set of link connectors, and a second interconnector configured to connect second link connectors in a second set of link connectors, the interconnectors having leads to connect the modules in a second dimension, two assemblies being connectable in the second dimension by removing the first interconnector from a first assembly and the second interconnector from a second assembly and connecting the respective first and second sets of link connectors.

9. The assembly of claim 8 wherein the backplane has leads for interconnecting the modules in a third dimension.

10. The assembly of claim 8 wherein four assemblies are connectable in the second dimension by removing the first interconnector from the second assembly, both interconnectors from a third assembly, and the second interconnector from a fourth assembly, and connecting the first set of link connectors of the second assembly with the second set of link connectors of the third assembly, and the first set of link connectors of the third assembly with the second set of link connectors of the fourth assembly.

11. The assembly of claim 10 wherein the backplane has leads for interconnecting the modules in a third dimension.

12. A fabric of modules comprising:
in at least one array of modules, at least two physically offset adjacent modules connected in at least a first dimension; and
one or two filler modules that occupy respective open slots physically adjacent to the at least two adjacent modules, the filler module being connected to the at least two adjacent modules in the first dimension and a second dimension to form an additional fabric link between two adjacent modules adjacent to the filler module.

13. The fabric of modules of claim 12 wherein the at least two physically offset adjacent modules includes three modules interconnected in the first and second dimensions, and the at least one filler module includes two filler modules.

14. The fabric of claim 13 wherein the at least two physically offset adjacent modules includes four or more modules interconnected in the first, second, and third dimensions.

15. The fabric of claim 14 wherein the at least one filler module includes two filler modules.

16. A method of connecting a fabric of modules comprising:
in at least one linear array of modules with a plurality of physically offset adjacent modules, connecting single offset modules in a ring with first dimension links;
connecting with second dimension links in at least one ring with substantially all links between modules in each array being double offset links bypassing a single module; and
connecting with third dimension links in at least one ring with substantially all links between modules in each array being triple offset links bypassing two modules.

17. The method of claim 16 wherein connecting with the second dimension links includes forming two rings, each ring being formed of five modules with all links between modules in each of the rings being double offset.

18. The method of claim 16 wherein connecting with the third dimension links includes interconnecting plural arrays of modules to extend the at least one ring.

19. The method of claim 16 wherein the connecting with the third dimension links includes forming a first ring with four modules, and a second ring with six modules.

20. The method of claim wherein the forming the first ring includes connecting between the four modules of the first ring with offsets of 1, 3, 3, and 3, and the forming the second ring includes connecting between the six modules of the second ring with offsets of 3, 3, 5, 3, 3, and 3.

21. A method of connecting an assembly of modules in a fabric comprising:
receiving modules in respective module connections in a backplane, and interconnecting the modules in at least a first dimension with leads of the backplane; and
connecting first and second sets of link connectors with first and second interconnectors having leads to connect the modules in a second dimension, two assemblies being connectable in the second dimension by removing the first interconnector from a first assembly and the second interconnector from a second assembly and connecting the respective first and second sets of link connectors.

22. The method of claim 21 further comprising interconnecting the modules in a third dimension.

23. The method of claim 21 wherein four assemblies are connectable in the second dimension by removing the first interconnector from the second assembly, both interconnectors from a third assembly, and the second interconnector from a fourth assembly, and connecting the first set of link connector of the second assembly with the second set of link connectors of the third assembly, and the first set of link connectors of the third assembly with the second set of link connectors of the fourth assembly.

24. A method of connecting modules in a fabric comprising:
in at least one array of modules, connecting at least two physically offset adjacent modules in at least a first dimension; and
connecting one or two filler modules to the at least two adjacent modules in the first dimension and a second dimension, the one or two filler modules occupying respective open slots physically adjacent to the at least two adjacent modules.

25. The method of claim 24 wherein the at least two physically offset adjacent modules includes three modules interconnected in the first and second dimensions, and the at least one filler module includes two filler modules.

26. The method of claim 24 wherein the at least two physically offset adjacent modules includes four or more modules interconnected in the first, second, and third dimensions.
